(19) United States
(12) Patent Application Publication
(10) Pub. No.: US 2011/0011361 A1
(43) Pub. Date: Jan. 20, 2011

(54) COUPLING DEVICE

(75) Inventor: Jeffrey A. Roberts, Wolcott, CT (US)

Correspondence Address: Nelson Mullins Riley & Scarborough LLP;IP Department, 100 North Tryon Street, 42nd Floor, Charlotte, NC, 28202-4000, US

(73) Assignee: KOYO BEARINGS USA LLC, Westlake, OH (US)

(21) Appl. No.: 12/935,314

(22) PCT Filed: Jun. 18, 2008
(86) PCT No.: PCT/US08/67303

§ 371 Date: Sep. 29, 2010

(51) Int. Cl. F01L 1/24; B23P 11/00; F16B 2/20

(52) U.S. Cl. 123/90.55; 29/525.05; 24/458

(57) ABSTRACT

A device (22) is adapted to couple a finger follower (14) and a hydraulic lash adjuster (18) for use in a valve train (10) of an engine. The hydraulic lash adjuster (18) includes a plunger (34) having a longitudinal axis. The finger follower (14) includes a pocket (30) for receiving the plunger (34) and a protrusion (54) proximate the pocket (30). The device (22) includes a first portion (66) having an outer peripheral edge (70) and an inner peripheral edge (74), which defines a first aperture (82) configured to receive the plunger (34). The inner peripheral edge (74) of the first portion (66) includes at least one radially inwardly-projecting tang (86) configured to frictionally engage the plunger (34) to substantially axially secure the first portion (66) to the plunger (34). The device (22) also includes a second portion (78) coupled to the first portion (66) and extending substantially non-parallel to the first portion (66). The second portion (78) includes an inner peripheral edge (98) defining a second aperture (102) configured to receive the protrusion (54) on the finger follower 14).

### FIELD OF THE INVENTION

The present invention relates to couplings, and more particularly to couplings for use in connecting valve train components of an engine.

### BACKGROUND OF THE INVENTION

When creating an assembly of components, it is often desirable to create multiple sub-assemblies, or “unitize” multiple individual components, to simplify or facilitate the assembly process. A valve train of an engine includes many components, and depending on the number of cylinders in the engine, assembling all of the valve train components may require a significant amount of time and precision when handling and connecting the individual components.

### SUMMARY OF THE INVENTION

Unitizing two or more valve train components in an engine can reduce the amount of time and precision required when handling and connecting the unitized components.

The present invention provides, in one aspect, a device adapted to couple a finger follower and a hydraulic lash adjuster for use in a valve train of an engine. The hydraulic lash adjuster includes a plunger having a longitudinal axis. The finger follower includes a pocket for receiving the plunger and a protrusion proximate the pocket. The device includes a first portion having an outer peripheral edge and an inner peripheral edge. The inner peripheral edge defines a first aperture configured to receive the plunger and at least one radially inwardly-projecting tang extending from the inner peripheral edge of the first portion. The tang is configured to frictionally engage the plunger to substantially axially secure the first portion to the plunger. The device also includes a second portion coupled to the first portion and extending substantially non-parallel to the first portion. The second portion has an inner peripheral edge that defines a second aperture configured to receive the protrusion on the finger follower.

The present invention provides, in another aspect, a unitized valve train assembly including a finger follower having a pocket, a protrusion proximate the pocket, and a hydraulic lash adjuster having a plunger received within the pocket of the finger follower. The plunger defines a longitudinal axis. The unitized valve train assembly also includes a coupling device having a first portion with an outer peripheral edge and an inner peripheral edge. The inner peripheral edge defines a first aperture through which the plunger is received. The coupling device also includes at least one radially inwardly-projecting tang extending from the inner peripheral edge of the first portion. The tang frictionally engages the plunger to substantially axially secure the first portion to the plunger. The coupling device further includes a second portion coupled to the first portion and extending substantially non-parallel to the first portion. The second portion has an inner peripheral edge defining a second aperture through which the protrusion on the finger follower is received.

The present invention provides, in yet another aspect, a method of coupling a finger follower and a hydraulic lash adjuster for use in a valve train of an engine. The finger follower has a pocket for receiving a plunger of the hydraulic lash adjuster and a protrusion proximate the pocket. The method includes providing a clip having a first aperture therethrough and at least one radially inwardly-projecting tang extending into the first aperture, inserting the plunger through the first aperture, deflecting the tang during insertion of the plunger through the first aperture, positioning the plunger within the pocket of the finger follower, and inserting the protrusion on the finger follower through a second aperture in the clip. The second aperture has a second axis substantially non-parallel to a first axis of the first aperture.

Other features and aspects of the invention will become apparent by consideration of the following detailed description and accompanying drawings.

### BRIEF DESCRIPTION OF THE DRAWINGS

FIG. 1 is a front perspective view of a unitized valve train assembly, including a coupling device of the present invention coupling a roller finger follower and a hydraulic lash adjuster.

FIG. 2 is a side perspective view of the unitized valve train assembly of FIG. 1.

FIG. 3 is a side view of the unitized valve train assembly of FIG. 1.

FIG. 4 is a top perspective view of the unitized valve train assembly of FIG. 1.

FIG. 5 is a top perspective view of the coupling device of FIG. 1 prior to assembly of the unitized valve train assembly.

FIG. 6 is a top view of the coupling device of FIG. 1 prior to assembly of the unitized valve train assembly.

FIG. 7 is a partial cross-sectional view of the coupling device and the hydraulic lash adjuster of the unitized valve train assembly of FIG. 1, illustrating the coupling device prior to coupling with the hydraulic lash adjuster.

FIG. 8 is a partial cross-sectional view of the coupling device and the hydraulic lash adjuster of the unitized valve train assembly of FIG. 1, illustrating the coupling device coupled with the hydraulic lash adjuster.

FIG. 9 is a side, partial cross-sectional view of the unitized valve train assembly of FIG. 1, illustrating the roller finger follower being positioned to engage the hydraulic lash adjuster.

FIG. 10 is a side, partial cross-sectional view of the unitized valve train assembly of FIG. 1, illustrating the coupling device engaging the roller finger follower.

FIG. 11 is a side, partial cross-sectional view of the unitized valve train assembly of FIG. 1, illustrating the coupling device coupling the roller finger follower and the hydraulic lash adjuster.

FIG. 12 is a side, partial cross-sectional view of the unitized valve train assembly of FIG. 1, illustrating the roller finger follower in a first orientation relative to the coupling device and hydraulic lash adjuster.

FIG. 13 is a side, partial cross-sectional view of the unitized valve train assembly of FIG. 1, illustrating the roller finger follower in a second orientation relative to the coupling device and hydraulic lash adjuster.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

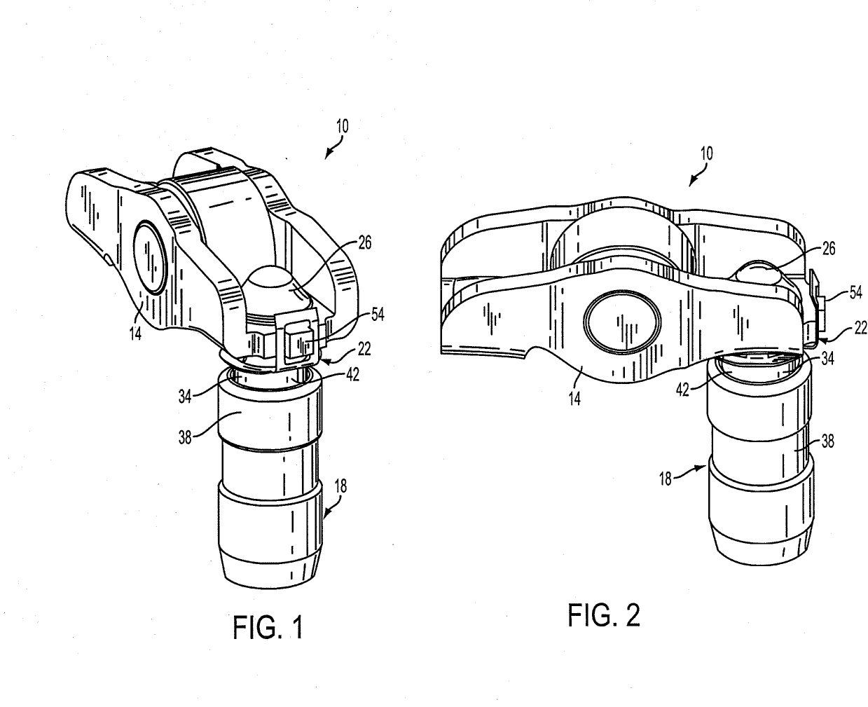

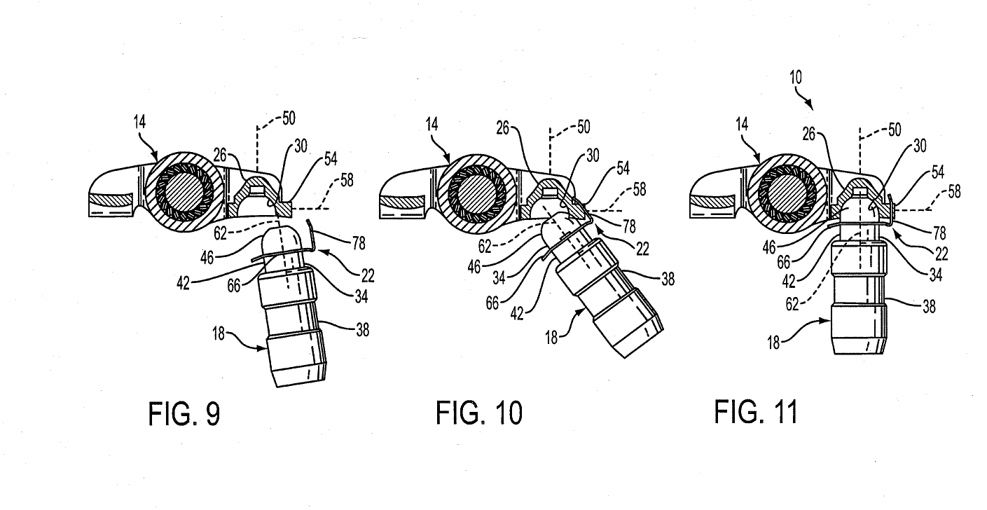

FIGS. 1-4 illustrate a unitized valve train assembly 10 including a rocker arm or a spherical-end pivoting, roller cam follower assembly or roller finger follower 14, a hydraulic lash adjuster 18, and a clip or coupling device 22 for unitizing or coupling the follower 14 and the adjuster 18. The follower 14 includes a ball socket 26 having a pocket 30 (see FIGS. 9-13), defining a central axis 50, in which the spherical-pivot component of the adjuster 18, customarily a piston or plunger 34 of the adjuster 18, is received. With reference to FIG. 9, the follower 14 also includes a protrusion 54 proximate the pocket 30. The protrusion 54 defines a longitudinal axis 58 oriented substantially normal to the central axis 50 of the pocket 30 and extends in a direction away from the pocket 30 (see FIGS. 9-11).

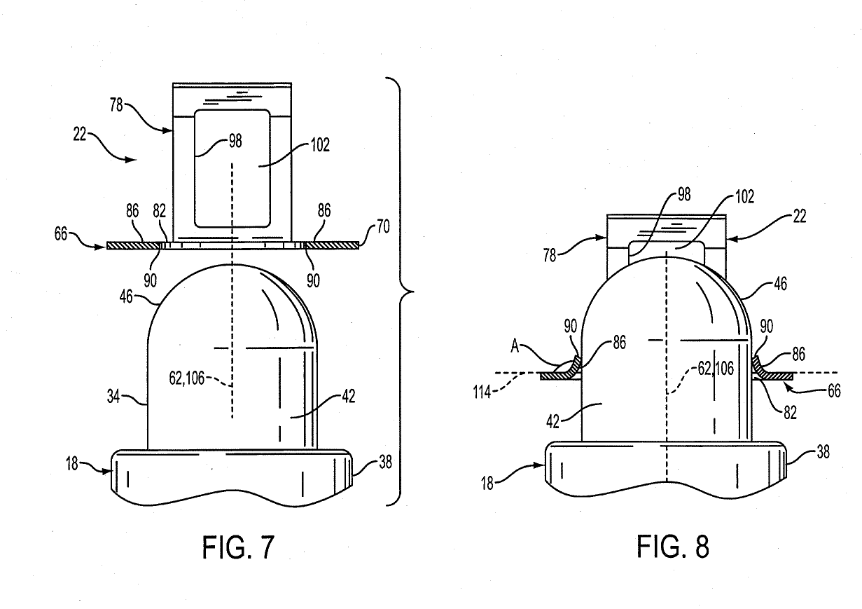

With reference to FIGS. 1-4, the adjuster 18 includes a housing 38 in which the plunger 34 is supported. The plunger 18 defines a longitudinal axis 62 and includes a shank 42 and a substantially hemispherical or semi-spherical end portion 46 (hereinafter “spherical end portion 46”), which engages the pocket 30 of the follower 14 (see FIGS. 7-11). The spherical end portion 46 of the plunger 34 may be truncated (as shown in FIGS. 9-13), or the spherical end portion 46 of the plunger 34 may not be truncated (as shown in FIGS. 7 and 8). As would be understood by one of ordinary skill in the art, the coupling device 22 may be utilized with either the non-truncated plunger 34 of FIGS. 7 and 8 or the truncated plunger 34 of FIGS. 9-13. The unitized valve train assembly 10 of FIGS. 1-4 may be used, for example, in an engine having an overhead camshaft configuration.

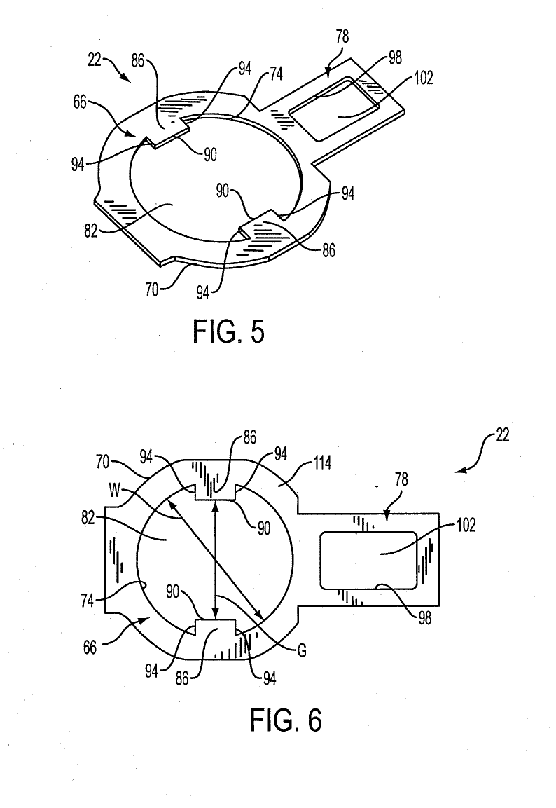

With reference to FIGS. 5 and 6, the coupling device 22 (shown as manufactured) includes a first portion 66, having an outer peripheral edge 70 and an inner peripheral edge 74, and a second portion 78 coupled to the outer peripheral edge 70 of the first portion 66. The inner peripheral edge 74 defines a first aperture 82 having a width dimension W (see FIG. 6). In the illustrated construction of the coupling device 22, the aperture 82 is substantially circular, and the width dimension W corresponds to the diameter of the aperture 82. Alternatively, the aperture 82 may be configured in any of a number of different shapes (e.g., oblong, rectangular, etc.).

With reference to FIGS. 5 and 6, the first portion 66 of the coupling device 22 includes opposed radially inwardly-projecting tangs 86. Each of the tangs 86 includes a substantially straight distal edge 90 and respective side edges 94 on either side of the distal edge 90. In the illustrated construction of the coupling device 22, the side edges 94 of each of the tangs 96 are oriented substantially normal to the distal edge 90 to impart a substantially rectangular shape to each of the tangs 86. Alternatively, the tangs 86 may be configured with a different shape (e.g., rounded, slanted, notched, triangular, polygonal, etc.). Further, in yet other constructions, the coupling device 22 may include only a single tang 86, or three or more tangs 86, equally or unequally spaced about the inner peripheral edge 74 of the first portion 66.

With reference to FIG. 6, the tangs 86 define a gap dimension G between the respective distal edges 90 of the tangs 86. In the illustrated construction of the coupling device 22, a ratio of the gap dimension G to the width dimension W is about 0.77:1. Alternatively, the coupling device 22 may be configured to provide a ratio of the gap dimension G to the width dimension W between about 0.7:1 and about 1:1. As will be discussed in greater detail below, the gap dimension G is slightly less than an outer diameter of the plunger shank 42 so as to frictionally engage and substantially axially secure the coupling device 22 to the plunger 34 (see also FIGS. 7 and 8).

With reference to FIGS. 5 and 6, the second portion 78 of the coupling device 22 includes an inner peripheral edge 98 defining a second aperture 102. In the illustrated construction of the coupling device 22, the aperture 102 is rectangular. However, in alternative constructions of the coupling device 22, the aperture 102 may be configured in any of a number of different shapes (e.g., rounded, oblong, polygonal, etc.). As will be discussed in greater detail below, the second aperture 102 is configured to receive the protrusion 54 of the finger follower 14 to allow the finger follower 14 to pivot through its full range of motion during operation (see FIGS. 1-4, 12, and 13).

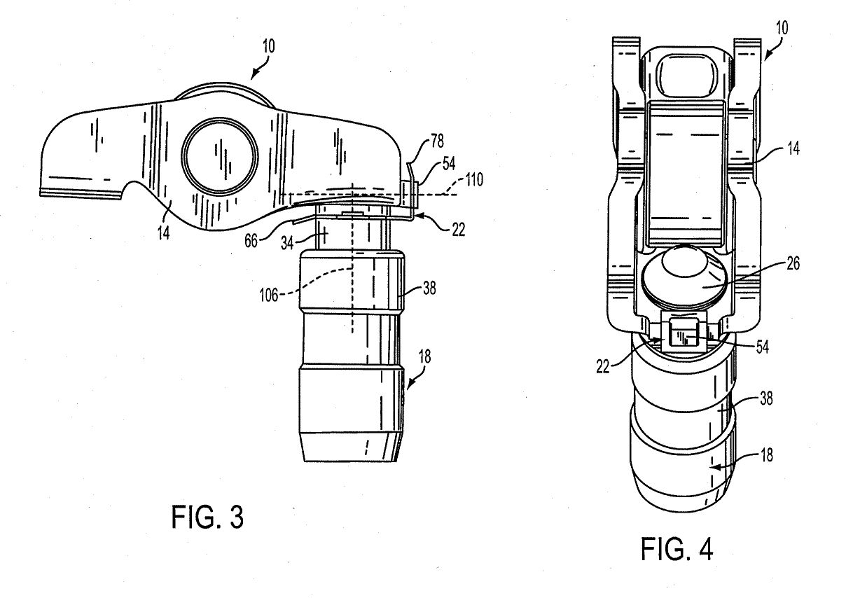

FIGS. 5 and 6 illustrate the coupling device 22 immediately subsequent manufacturing, in a pre-assembled state, and prior to bending the second portion 78 relative to the first portion 66. Prior to bending, the first portion 66 and the second portion 78 are formed substantially coplanar by stamping, or a like process, from a single piece of resilient material (e.g., sheet steel). Subsequently, prior to attachment to the plunger 34, the second portion 78 of the coupling device 22 may be bent relative to the first portion 66 such that axes 106, 110 of the first and second apertures 82, 102, respectively, are substantially normal to each other (see FIG. 3). The coupling device 22 may also be bent or deformed in other locations of the first and second portions 66, 78 to prevent interference with the follower 14 during its operation (see FIG. 3).

FIGS. 7 and 8 illustrate a sequence of assembling the coupling device 22 onto the adjuster 18. With reference to FIG. 7, the coupling device 22 is initially positioned above the adjuster 18, and the respective axes 106, 62 of the first aperture 82 and the plunger 34 are substantially aligned. The coupling device 22 is then coupled to or pushed onto the plunger 34. The width dimension W is nominally equal to or slightly larger than the outer diameter of the plunger shank 42. Therefore, the plunger 34 may be received within the first aperture 82 without any or without significant interference with the inner peripheral edge 74. However, because the gap dimension G (in the pre-assembled state of the coupling device 22 shown in FIG. 7) is less than the outer diameters of the plunger shank 42 and spherical end portion 46, the tangs 86 engage the spherical end portion 46 of the plunger 34 and are deflected upwardly at an oblique angle A (see FIG. 8) with respect to a plane 114 defined by the top surface of the first portion 66. In the illustrated construction of the coupling device 22, each of the tangs 86 forms an oblique angle A of about 115 degrees relative to the plane 114. Alternatively, the tangs 86 may be configured to yield an oblique angle A more than or less than about 115 degrees.

The frictional engagement of the deflected tangs 86 with the plunger shank 42 (specifically, the engagement of the respective distal edges 90 and the plunger shank 42) provides resistance to the disconnection of the coupling device 22 and the plunger 34. As such, the coupling device 22 is axially secured to the plunger 34 relative to the longitudinal axis 62 of the plunger 34. The subassembly of the adjuster 18 and the coupling device 22 is fully unitized and can be handled without substantial concern of causing unintentional disassembly. Alternatively, the second portion 78 of the coupling device 22 may be bent relative to the first portion 66 after the device 22 is coupled to the plunger 34.

With reference to FIGS. 9-11, a sequence of assembling the follower 14 and the unitized adjuster 18 and coupling device 22 is shown. FIG. 9 illustrates the unitized adjuster 18 and coupling device 22 oriented such that the spherical end portion 46 of the plunger 34 may be received in the pocket 30 of the follower 14. Then, the protrusion 54 on the follower 14 is at least partially inserted into the second aperture 102 of the coupling device 22, and the unitized subassembly of the adjuster 18 and the coupling device 22 is pivoted to allow initial insertion of the spherical end portion 46 of the plunger 34 into the pocket 30 of the follower 14 (see FIG. 10). From the orientation of the follower 14 and the adjuster 18 shown in FIG. 10, the coupling device 22 and adjuster 18 are further pivoted to allow the spherical end portion 46 to be received within the pocket 30 and the protrusion 54 to be inserted through the second aperture 102 (see FIG. 11).

The unitized valve train assembly 10 may be assembled using a different method than that described above. For example, the coupling device 22 (as shown in FIGS. 5 and 6) may first be inserted onto the plunger 34 of the adjuster 18, thereby causing deflection of the tangs 86, as described above. Next, the spherical end portion 46 of the plunger 34 may be inserted into the pocket 30 of the follower 14. Lastly, the second portion 78 of the coupling device 22 may be bent upwardly over the protrusion 54 of the follower 14 such that the protrusion 54 is received within the second aperture 102.

Using yet another alternative assembly method, the second portion 78 of the coupling device 22 may first be bent relative to the first portion 66, as previously described. Next, the protrusion 54 of the follower 14 may be inserted through the second aperture 102, and the respective axes 50, 106 of the pocket 30 and the first aperture 82 may be aligned. A spacer (not shown) may be inserted between the follower 14 and at least a portion of the top surface of the first portion 66 lying in the plane 114 to orient and maintain the position of the coupling device 22 relative to the follower 14. The plunger 34 may then be inserted through the first aperture 82 of the coupling device 22 and into the pocket 30 of the ball socket 26 on the follower 14, thereby bending or deflecting the tangs 86 as described above. The spacer allows the tangs 86 to frictionally engage the plunger 34 and deflect, as described above, while preventing the first portion 66 of the coupling device 22 from deflecting or being bent toward the follower 14. The spacer may be removed after the coupling device 22 is secured to the plunger 34. The follower 14, the adjuster 18, and the coupling device 22 may be assembled using yet other alternative methods resulting in the unitized valve train assembly 10.

After assembly, the follower 14 and adjuster 18 can now be handled as a unit, without substantial concern that the adjuster 18 may be unintentionally separated from the follower 14. To separate the adjuster 18 and the follower 14, the unitized subassembly of the adjuster 18 and the coupling device 22 may be pivoted back such that the protrusion 54 of the follower 14 is partially removed from the second aperture 102 of the coupling device 22 to allow removal of the spherical end portion 46 of the plunger 34 from the pocket 30 of the ball socket 26. The adjuster 18 can then be fully removed from the follower 14 without significantly bending or deforming the coupling device 22, or compromising the functionality of the follower 14, the adjuster 18, or the coupling device 22.

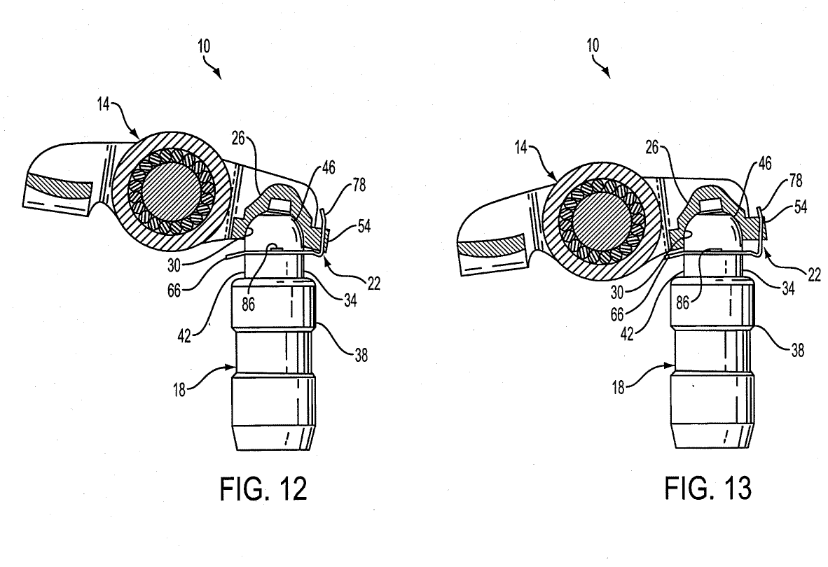

With reference to FIGS. 12 and 13, the follower 14 is loosely, but positively retained to the adjuster 18 by the coupling device 22. When installed in an engine application, sufficient clearance is provided by the geometry of the second aperture 102 of the coupling device 22 such that the follower 14 is able to pivot on the spherical end portion 46 of the plunger 34 through the necessary range of operating angles without causing damage to or binding of any components, including the follower 14 and the adjuster 18 themselves, due to interference. Contact between the coupling device 22 and the follower 14 rarely occurs during operation, if ever, and will only potentially occur at times when the follower 14 is positioned at a peak in its range of operating angles.

The coupling device 22 facilitates handling of the follower 14 and the adjuster 18 as a unit, without substantial concern that the follower 14 and the adjuster 18 may become unintentionally separated, without requiring any special features on the adjuster 18 (e.g., an undercut of the plunger shank 42), and without impeding the intended motion of either the follower 14 or the adjuster 18.

Once the unitized valve train assembly 10 is installed in a fully assembled engine, the coupling device 22 is no longer needed to keep the follower 14 assembled to the adjuster 18. Rather, the coupling device 22 is only needed to keep the follower 14 from unintentionally separating from the adjuster 18 when the engine is only partially assembled. Therefore, during operation of the fully assembled engine, little or no contact between the protrusion 54 on the follower 14 and the inner peripheral edge 98 of the second portion 78 occurs because repeated contact may lead to wear or breakage of the coupling device 22. Contact between the protrusion 54 on the follower 14 and the inner peripheral edge 98 of the second portion 78 usually only occurs during assembly, either when the adjuster 18 is installed onto the follower 14, or when the adjuster 18 is being prevented from unintentionally separating from the follower 14.

Various features of the invention are set forth in the following claims.

What is claimed is:

1. A device adapted to couple a finger follower and a hydraulic lash adjuster for use in a valve train of an engine, the hydraulic lash adjuster having a plunger defining a longitudinal axis, the finger follower having a pocket for receiving the plunger and a protrusion proximate the pocket, the device comprising:
a first portion having an outer peripheral edge and an inner peripheral edge, the inner peripheral edge defining a first aperture configured to receive the plunger;
at least one radially inwardly-projecting tang extending from the inner peripheral edge of the first portion, the tang configured to frictionally engage the plunger to substantially axially secure the first portion to the plunger; and
a second portion coupled to the first portion and extending substantially non-parallel to the first portion, the second portion having an inner peripheral edge defining a second aperture configured to receive the protrusion on the finger follower.

2. The device of claim 1, wherein the at least one radially inwardly-projecting tang includes a pair of opposed radially inwardly-projecting tangs engaged with the plunger.

3. The device of claim 2, wherein each of the opposed radially inwardly-projecting tangs includes a substantially straight distal edge configured to frictionally engage the plunger, wherein the first portion defines a gap dimension between the respective distal edges of the opposed radially inwardly-projecting tangs, wherein the inner peripheral edge of the first aperture defines a width dimension, and wherein a ratio of the gap dimension to the width dimension is between about 0.7:1 and about 1:1.

4. The device of claim 1, wherein the first portion and the at least one radially inwardly-projecting tang are integrally formed as a single piece.

5. The device of claim 4, wherein the second portion is integrally formed as a single piece with the first portion and the at least one radially inwardly-projecting tang.

6. The device of claim 1, wherein the at least one radially inwardly-projecting tang includes a substantially straight distal edge configured to frictionally engage the plunger.

7. The device of claim 1, wherein the first aperture is substantially circular, and wherein the second aperture is substantially rectangular.

8. The device of claim 1, wherein the second portion is coupled to the outer peripheral edge of the first portion.

9. The device of claim 1, wherein the second portion extends substantially normal to the first portion.

10. A unitized valve train assembly comprising:
a finger follower including a pocket and a protrusion proximate the pocket;
a hydraulic lash adjuster including a plunger received within the pocket of the finger follower, the plunger defining a longitudinal axis; and
a coupling device including
a first portion having an outer peripheral edge and an inner peripheral edge, the inner peripheral edge defining a first aperture through which the plunger is received;
at least one radially inwardly-projecting tang extending from the inner peripheral edge of the first portion, the tang frictionally engaging the plunger to substantially axially secure the first portion to the plunger; and
a second portion coupled to the first portion and extending substantially non-parallel to the first portion, the second portion having an inner peripheral edge defining a second aperture through which the protrusion on the finger follower is received.

11. The unitized valve train assembly of claim 10, wherein the at least one radially inwardly-projecting tang includes a pair of opposed radially inwardly-projecting tangs engaged with the plunger.

12. The unitized valve train assembly of claim 11, wherein each of the opposed radially inwardly-projecting tangs includes a substantially straight distal edge frictionally engaged with the plunger, wherein the first portion defines a gap dimension between the respective distal edges of the opposed radially inwardly-projecting tangs, wherein the inner peripheral edge of the first aperture defines a width dimension, and wherein a ratio of the gap dimension to the width dimension is between about 0.7:1 and about 1:1.

13. The unitized valve train assembly of claim 10, wherein the first portion and the at least one radially inwardly-projecting tang are integrally formed as a single piece.

14. The unitized valve train assembly of claim 13, wherein the second portion is integrally formed as a single piece with the first portion and the at least one radially inwardly-projecting tang.

15. The unitized valve train assembly of claim 10, wherein the at least one radially inwardly-projecting tang includes a substantially straight distal edge frictionally engaged with the plunger.

16. The unitized valve train assembly of claim 10, wherein the first aperture is substantially circular, and wherein the second aperture is substantially rectangular.

17. The unitized valve train assembly of claim 10, wherein the first portion includes an upper surface defining a plane, and wherein the tang is oriented at an oblique angle relative to the plane when engaged with the plunger.

18. The unitized valve train assembly of claim 10, wherein the second portion is coupled to the outer peripheral edge of the first portion.

19. The unitized valve train assembly of claim 10, wherein the second portion extends substantially normal to the first portion.

20. A method of coupling a finger follower and a hydraulic lash adjuster for use in a valve train of an engine, the finger follower having a pocket for receiving a plunger of the hydraulic lash adjuster and a protrusion proximate the pocket, the method comprising:
providing a clip having a first aperture therethrough and at least one radially inwardly-projecting tang extending into the first aperture;
inserting the plunger through the first aperture;
deflecting the tang during insertion of the plunger through the first aperture;
positioning the plunger within the pocket of the finger follower; and
inserting the protrusion on the finger follower through a second aperture in the clip, the second aperture having a second axis substantially non-parallel to a first axis of the first aperture.
